(19) United States
(12) Patent Application Publication
(10) Pub. No.: US 2025/0279452 A1
(43) Pub. Date: Sep. 4, 2025

(54) METHOD AND DEVICE FOR HUMIDIFYING CATHODE AIR IN A FUEL CELL SYSTEM AND FUEL CELL SYSTEM

(71) Applicant: Robert Bosch GmbH, Stuttgart (DE)

(72) Inventors: Wolfgang Sander, Weissach (DE); Andreas Knoop, Esslingen (DE); Martin Katz, Stuttgart (DE)

(21) Appl. No.: 18/859,212

(22) PCT Filed: Apr. 20, 2023
(86) PCT No.: PCT/EP2023/060284

§ 371 Date: Oct. 23, 2024

(30) Foreign Application Priority Data
Apr. 29, 2022 (DE) 10 2022 204 241.7

(51) Int. Cl. H01M 8/04828; B01F 23/213; B01F 25/30; B01F 35/71; B01F 101/55; H01M 8/04119; H01M 8/0432; H01M 8/04701; H01M 8/04746

(52) U.S. Cl. CPC H01M 8/04835; B01F 23/213; B01F 25/30; B01F 35/714; H01M 8/04141; H01M 8/04156; H01M 8/04358; H01M 8/04716; H01M 8/04761; B01F 2101/55

(57) ABSTRACT

The invention relates to a method for humidifying air in a supply air path (2) of a fuel cell system (1) by means of water injection, wherein product water produced on the cathode side is used, with said product water being separated from the humid exhaust air introduced into the exhaust air path (3) with the aid of a water separator (4) integrated into the exhaust air path (3), wherein, depending on the load, the liquid water content of the exhaust air is varied by means of the temperature of the exhaust air.

The invention also relates to a device for humidifying air in a supply air path (2) of a fuel cell system (1) and to a fuel cell system (1) comprising a device according to the invention.

### BACKGROUND

The invention relates to a method and device for humidifying cathode air in a fuel cell system. In addition, the invention relates to a fuel cell system comprising a device for humidifying cathode air according to the invention.

A fuel cell converts oxygen and a fuel, for example water, into electrical energy, heat and water. As a rule, air taken from the surrounding environment serves as the oxygen source. The air is supplied to a cathode, the fuel of the fuel cell anode.

A large number of fuel cells are connected to form a fuel cell stack in order to increase the electrical output. For air supply, the fuel cell stack is connected to a supply air path. Since the energy conversion process requires a certain mass air flow and a certain pressure level, the air supplied via the supply air path is compressed with the aid of an air compressor arranged in the supply air path. The air is then adjusted to the correct humidity at the specified temperature. For humidification, water may particularly be used that is produced on the anode and/or cathode side during the energy conversion process, so-called product water. This can be collected in a water tank and, if necessary, dosed into the supply air path using a suitable metering device.

The use of product water to humidify the cathode air requires that a sufficient amount of product water is produced in the fuel cell system operation so that a certain amount of water is always present in the water tank. However, depending on the load, a negative water balance may occur, so that the water consumption exceeds the water inflow into the water tank. This may particularly be the case for medium to low loads. Especially during low-load operation, a sufficient water supply in the water tank must therefore be ensured.

### SUMMARY

This problem is addressed by the present invention. To solve the problem, the method and the device with the features of the disclosure are proposed. Furthermore, a fuel cell system comprising a device according to the invention is specified.

In the proposed method for humidifying air in a supply air path of a fuel cell system by means water injection, product water produced on the cathode side is used. The product water produced on the cathode side is separated from the humid exhaust air introduced into the exhaust air path using a water separator integrated into the exhaust air path. Depending on the load, the liquid water content of the exhaust air is varied by means of the temperature of the exhaust air.

The temperature of the exhaust air has a strong impact on ability of the air to absorb water. If the temperature of the exhaust air drops, the saturation state is reached faster so that the liquid water content of the exhaust air rises. By varying the liquid water content, the amount of water separated using the water separator can be controlled accordingly. Because the more liquid water the exhaust air contains, the more product water can be separated using the water separator and the more water is available for humidifying the air in the supply air path. By varying the liquid water content based on the temperature of the exhaust air, a negative water balance can thus be counteracted.

Since less product water is produced, especially at low loads, so that there is a risk of a negative water balance, it is proposed in a further development of the invention that the temperature of the exhaust air is lowered in the case of medium to low-level loads, so that the liquid water content of the exhaust air increases.

According to a preferred embodiment of the invention, the temperature of the exhaust air is controlled via the coolant temperature, in particular the coolant supply temperature, of a cooling circuit via which the waste heat of the fuel cell system generated during operation is removed. By adjusting the coolant temperature or the coolant supply temperature, the exhaust air temperature can and, via the exhaust air temperature, the liquid water content of the exhaust air can be controlled. In load cases with a negative water balance, especially at medium to low loads, the coolant temperature or the coolant supply temperature is lowered so that the liquid water content of the exhaust air increases and the water balance is at least balanced. In load cases with a positive water balance, i.e. at high loads, the coolant temperature or the coolant supply temperature may be increased again. Alternatively, excess product water may be discharged with the exhaust air via the exhaust air path.

The increase in cooling efficiency associated with lowering the coolant temperature or the coolant supply temperature is usually unproblematic in low load cases, as the cooling circuit is designed for high loads and the resulting waste heat. At the same time, water injection and evaporation of liquid water reduce waste heat in high load cases. Since the cooling circuit must be operated less dynamically, unloading of the cooling circuit can also be achieved.

Furthermore, it is proposed that the amount of water required for humidification is determined using the coolant temperature, in particular the coolant supply temperature, of the cooling circuit. That means that the temperature of the air in the supply air path no longer determines the amount of water required for humidification, but rather the coolant temperature and the coolant supply temperature, respectively. This leads to a lower water requirement as long as the actual temperature of the air in the supply air path is above the coolant temperature or the coolant supply temperature, respectively.

Because the cooling circuit has some inertia, the coolant temperature or the coolant supply temperature is preferably pilot controlled, preferably using information about future load requirements and/or learned experience values for pilot control. For example, the information about future load requirements may be provided via a navigation system.

Preferably, product water separated with the aid of the water separator is collected in a water tank and injected into the supply air path using a metering device. In order to ensure that there is always a sufficient amount of water for humidifying the air in the supply air path, complete emptying of the water tank should be avoided. Ideally, in addition to the product water produced on the cathode side, product water produced on the anode side is introduced into the water tank so that the entire amount of product water produced during operation of the fuel cell system is available for humidifying the air in the supply air path. Since there is typically a water separator for removing liquid water from the anode gas on the anode side, it only needs to be connected to the water tank.

Furthermore, it is suggested that the fill level in the water tank is monitored. With the help of fill level monitoring, a continuous water supply may be ensured.

Moreover, a device for humidifying air in a supply air path of a fuel cell system by means of water injection is proposed. The device comprises:
a water separator that is integrated into an exhaust air path to separate product water produced on the cathode side,
a water tank for collecting product water separated using the water separator, and
a metering device arranged at the supply air path and connected to the water tank via a water line.

The device is particularly suitable for carrying out the method according to the invention described above, so that the same advantages can be achieved. In particular, a negative water balance may be avoided by varying the temperature of the exhaust air depending on the load.

A pump is preferably integrated into the water line connecting the water tank to the metering device. With the aid of the pump, the supply of water to the metering device can be ensured. Furthermore, the water may be injected under pressure so that it is finely atomized upon injection. In this way, evaporation of the injected water may be promoted.

The water tank is preferably connected to a further water separator arranged on the anode side for separating product water produced on the anode side. In this way, the product water produced on both the cathode side and anode side may be used to humidify the air in the supply air path. As a result, a greater amount of water is also available.

Furthermore, a fuel cell system with a device according to the invention for humidifying air in a supply air path, via which a fuel cell stack is supplied with air, is proposed. With the aid of the device, the air supplied to the fuel cell stack may be preconditioned. In particular, the air can be set to the correct humidity at a predetermined temperature. Subsequently, the efficiency of the fuel cell stack increases.

### BRIEF DESCRIPTION OF THE DRAWINGS

The invention is explained in more detail below with reference to the accompanying drawings. Shown are:

FIG. 1 a schematic representation of an air system and a fuel cell system according to the invention and

FIG. 2 different diagrams illustrating a) the metering rate, product water produced on the cathode side and anode side, b) fill level in the water tank and coolant supply temperature, and c) power demand, each over time.

### DETAILED DESCRIPTION

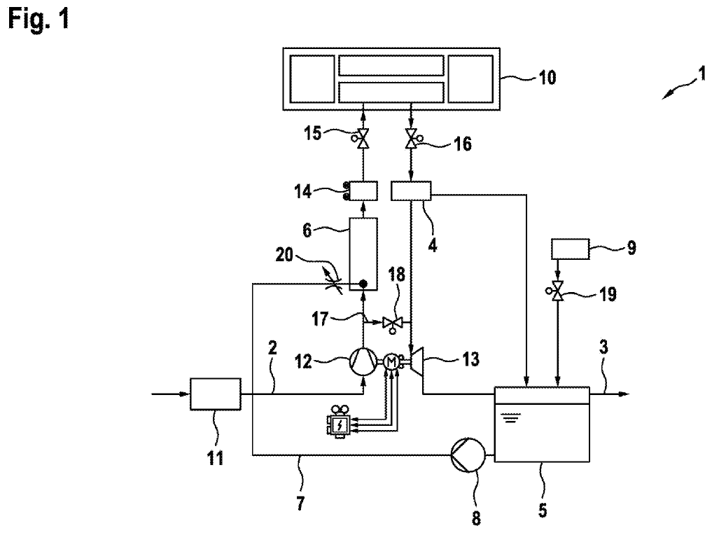

Air is supplied to a fuel cell stack 10 via the air system of a fuel cell system 1 shown in FIG. 1. The air is taken from the environment and first supplied to an air filter 11 via an air supply path 2. Downstream of the air filter 11, a compressor 12 is integrated into the supply air path 2, because the electrochemical reaction in the fuel cells requires a certain mass air flow and a certain pressure level. Downstream of the compressor 12, a metering device 6 is arranged by means of which water can be injected into the supply air path 2 to humidify the air prior to entering the fuel cell stack 10. To further condition the air, a cooler 14 is provided downstream of the metering device. The humid exhaust air exiting the fuel cell stack 10 is discharged via an exhaust air path 3, into which a water separator 4 is integrated. With the aid of the water separator 4, the liquid water content contained in the exhaust air is separated. Downstream of the water separator 4, a turbine 13 is integrated into the exhaust air path 3, which is operatively connected to the compressor 12 and serves for energy recovery. In the case of a shutdown, fuel cell stack 10 may be disconnected from the air system by way of check valves 15, 16. Furthermore, a bypass path 17 with an integrated bypass valve 18 is provided for bypassing the fuel cell stack 10.

The metering device 6 is connected via a water line 7 to a water tank 5, into which the product water separated from the exhaust air by means of the water separator 4 is introduced. Product water produced on the anode side can also be introduced into the water tank 5, which is separated with the aid of a water separator 9 located on the anode side. For this purpose, only a drain valve 19 located on the water separator 9 must be opened.

If a sufficient amount of water is present in the water tank 5, it may be supplied to the metering device 6 with the aid of a pump 8. Using the metering device 6, a certain amount of water may then be injected into the supply air path for humidifying the air. The metering can be effected, for example with the aid of a metering valve 20 of the metering device 6.

The amount of water present in water tank 5 varies depending on the load, so that there is a risk that the product water produced, or the water supply stored in water tank 5, is not sufficient to meet the water demand required for humidifying the air. According to the present invention, the water supply is therefore controlled on a load-dependent basis via the temperature of the exhaust air in the exhaust air path. Particularly at low loads, the temperature of the exhaust air is lowered so that the liquid water content of the exhaust air increases. To lower the exhaust air temperature, preferably the coolant supply temperature of a cooling circuit (not shown) is reduced, which serves to remove the waste heat of the fuel cell stack 10 generated during operation. With the liquid water content of the exhaust air, the water supply in the water tank 5 also increases.

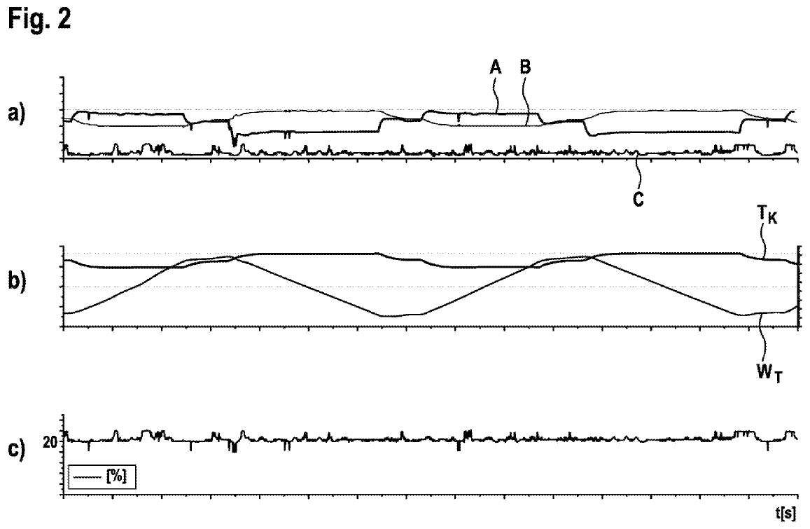

The relationship between the coolant supply temperature T_{K} and the water supply W_{T} in the water tank 5 is exemplarily illustrated in the diagram of FIG. 2b). When the temperature T_{K} is temporarily lowered compared to a nominal value Tₙₒₘ, the water supply W_{T} in the water tank 5 increases. Accordingly, the amount of product water produced on the cathode side (curve A) and the metering rate (curve B) will vary, as shown in the diagram of FIG. 2a). The additional curve C of FIG. 2a) indicates the amount of product water produced on the anode side. The curves were determined at low load, that is, at a power demand of about 20% (see FIG. 2c)).

1. A method for humidifying air in a supply air path (2) of a fuel cell system (1) by means of water injection, wherein product water produced on the cathode side is used, with said product water being separated from the humid exhaust air introduced into the exhaust air path (3) with the aid of a water separator (4) integrated into the exhaust air path (3), wherein, depending on the load, the liquid water content of the exhaust air is varied by means of the temperature of the exhaust air.

2. The method according to claim 1, wherein, for medium to low loads, the temperature of the exhaust air is lowered so that the liquid water content of the exhaust air increases.

3. The method according to claim 1, wherein the temperature of the exhaust air is controlled via the coolant temperature of a cooling circuit via which the waste heat of the fuel cell system (1) generated during operation is removed.

4. The method according to claim 3, wherein the amount of water required for humidification is determined using the coolant temperature of the cooling circuit.

5. The method according to claim 3, wherein the coolant temperature, is pilot operated, preferably using information concerning future load requirements and/or learned pilot experience values.

6. A method according to claim 1, one of the preceding claims,
wherein product water separated with the aid of the water separator (4) is collected in a water tank (5) and injected into the supply air path (2) with the aid of a metering device (6).

7. The method according to claim 6, wherein the fill level in the water tank (5) is monitored.

8. A device for humidifying air in a supply air path (2) of a fuel cell system (1) by water injection, comprising
a water separator (4) that is integrated into an exhaust air path (3) to separate product water produced on the cathode side,
a water tank (5) for collecting the product water separated using the water separator (4), as well as
a metering device (6) located at the supply air path (2) and connected to the water tank (5) via a water line (7).

9. The device according to claim 8, wherein a pump (8) is integrated into the water line (7).

10. The device according to claim 8, wherein the water tank (5) is connected to a further water separator (9), which is located on the anode side for separating product water produced on the anode side.

11. A fuel cell system (1) comprising a device according to claim 8 for humidifying air in a supply air path (2) via which a fuel cell stack (10) is supplied with air.
